(19) United States
(12) Patent Application Publication
(10) Pub. No.: US 2019/0080091 A1
(43) Pub. Date: Mar. 14, 2019

(54) METHOD AND DEVICE FOR VERIFYING INTEGRITY BY USING TREE STRUCTURE

(71) Applicant: Samsung Electronics Co., Ltd., Suwon-si (KR)

(72) Inventors: Kun-yong KIM, Suwon-si (KR); Sang-hoon Jeon, Hwaseong-si (KR); Hyung-sup Kim, Hwaseong-si (KR)

(73) Assignee: Samsung Electronics Co., Ltd., Suwon-si (KR)

(21) Appl. No.: 16/108,403

(22) Filed: Aug. 22, 2018

(30) Foreign Application Priority Data
Sep. 12, 2017 (KR) 10-2017-0116659

(51) Int. Cl. G06F 21/57; H04L 29/06; H04L 9/32; G06F 21/64; G06F 21/71; H04L 9/08

(52) U.S. Cl. CPC G06F 21/57; H04L 63/123; H04L 9/0866; G06F 21/64; G06F 21/71; H04L 9/3242

(57) ABSTRACT

A method of verifying integrity of an Internet of Things (IoT) system including a hub device and a plurality of end-node devices includes: determining, by the hub device, a root device among the plurality of end-node devices; receiving, by the hub device, from the root device at least one root message authentication code generated based on a result of verifying integrity of a sub-tree of the root device, wherein the sub-tree of the root device comprises a subset of the plurality of end-node devices subordinate to the root device; and verifying, by the hub device, the at least one root message authentication code.

### CROSS-REFERENCE TO RELATED APPLICATION

This application claims the benefit of Korean Patent Application No. 10-2017-0116659, filed on Sep. 12, 2017, in the Korean Intellectual Property Office, the disclosure of which is incorporated herein in its entirety by reference.

### BACKGROUND

The inventive concepts relate to a method of verifying integrity of a system, and more particularly, to a method and device for verifying integrity by using a tree structure and a symmetric key.

Various pieces of data are newly produced due to the development of information technology (IT) and more data to be protected such as personal information is increased. Various threats to data have also become diverse and intelligent, requiring a high level of encryption technology to protect the various data. In order to protect a system from external security threats, authentication, integrity verification, or the like of a device using encryption technology may be performed.

In particular, when various devices are interconnected in an Internet of Things (IoT) system, there may be security vulnerability such that a whole interconnected IoT system that is related to human life may be attacked by a single external threat. Therefore, the IoT system may require high-level encryption technology, and various schemes have been proposed to achieve it.

For example, two kinds of encryption technology may be implemented in an IoT system: one using a symmetric encryption key (a secret key), and one using asymmetric keys (a public key and private key pair). With asymmetric encryption technology, the key used for encryption is different from the key used for decryption. Accordingly, a level of security may be increased by utilizing asymmetric encryption. However, there may be a problem in that it is difficult and time-consuming, due to a large amount of complex, computationally-intensive and resource-consuming cryptographic operations, to apply asymmetric encryption technology to an IoT device which may have a relatively limited amount of resources (e.g., memory availability, processing capabilities, battery power, etc.). On the other hand, symmetric encryption technology involves a relatively smaller amount of cryptographic operations that consume less time and resources. However, because the same symmetric key that is used for both encryption and decryption must be shared between the devices performing the encryption and decryption operations, the IoT system may potentially be exposed to external threats (e.g., from malware attacks). Therefore, methods, systems, and devices which maintain a high level of security while using symmetric encryption technology for verifying integrity of a system comprising IoT devices are desirable.

### SUMMARY

In order to solve the aforementioned problems, improved methods, systems, and devices according to various example embodiments of the inventive concepts use an authentication key shared between a hub device and an end-node device as a symmetric key. The authentication key may be indirectly shared by using an authentication message, without directly sharing the authentication key, thereby reducing or preventing exposure of the authentication key to external threats such as malware attacks. While using the authentication key as a symmetric key, all devices may share software configuration for security enhancement, form a tree structure to verify integrity in various steps, and in particular, may use process memory map information and security policy information during the software configuration. In addition, a chain message authentication code (MAC) may be utilized to further enhance security.

Some example embodiments of the inventive concepts provide a method of verifying integrity of an Internet of Things (IoT) system, a device for implementing the method, and a method of verifying integrity of a network system, in which security of a system is further strengthened by forming a tree structure using a plurality of devices that share respective software configuration values in advance, and encryption technology is applied to devices having relatively fewer resources (e.g., resource-constrained mobile devices and/or IoT devices having limited available memory, processing capabilities, battery power, etc.) by using an authentication key of the network system as a symmetric key.

According to some example embodiments of the inventive concepts, there is provided a method of verifying integrity of an Internet of Things (IoT) system including a hub device and a plurality of end-node devices, the method including: determining, by the hub device, a root device among the plurality of end-node devices; receiving, by the hub device from the root device, at least one root message authentication code generated based on a result of verifying integrity of a sub-tree of the root device, wherein the sub-tree of the root device comprises a subset of the plurality of end-node devices subordinate to the root device at a time of integrity verification; and verifying, by the hub device, the at least one root message authentication code.

According to some example embodiments of the inventive concepts, there is provided a hub device communicating with a plurality of end-node devices, the hub device comprising: a memory configured to store computer-readable instructions; and at least one processor configured to execute the computer-readable instructions to command the hub device to perform operations for verifying integrity of the plurality of end-node devices including, determining a root end-node device among the plurality of end-node devices and forming a tree structure with the root end-node device as a root node; receiving at least one root message authentication code from the root end-node device; and encrypting the at least one root message authentication code by using an authentication key of the root end-node device.

According to some example embodiments of the inventive concepts, there is provided a method of verifying integrity of a network system comprising a server and a plurality of clients, the method comprising: receiving, by a root client determined arbitrarily among the plurality of clients, at least one child message authentication code from a child client of the root client; verifying, by the root client, integrity of the at least one received child message authentication code; generating, by the root client, at least one root message authentication code by using an authentication key of the root client based on a result of verifying the integrity of the at least one received child message authentication code and a software configuration value of the root client, wherein the authentication key of the root client is stored in the root client; and transmitting, by the root client, the at least one root message authentication code to the server for verification.

### BRIEF DESCRIPTION OF THE DRAWINGS

Some example embodiments of the inventive concepts will be more clearly understood from the following detailed description taken in conjunction with the accompanying drawings in which:

FIG. 1 illustrates a network system according to some example embodiments of the inventive concepts;

FIG. 2 illustrates a protocol of encryption technology using a symmetric key according to some example embodiments of the inventive concepts;

FIG. 3 illustrates a network authentication system according to some example embodiments of the inventive concepts;

FIG. 4 illustrates an authentication key generation protocol according to some example embodiments of the inventive concepts;

FIG. 5 illustrates an authentication message generation protocol according to some example embodiments of the inventive concepts;

FIG. 6 illustrates a network system according to some example embodiments of the inventive concepts;

FIG. 7 is a flowchart of a network preparation phase according to some example embodiments of the inventive concepts;

FIG. 8 illustrates a network system according to some example embodiments of the inventive concepts;

FIG. 9 is a flowchart of a method of verifying integrity of a network according to some example embodiments of the inventive concepts;

FIG. 10 illustrates a parent-child system according to some example embodiments of the inventive concepts;

FIG. 11 is a flowchart of a verification loop according to some example embodiments of the inventive concepts;

FIG. 12 is a flowchart of a method of generating a child message authentication code according to some example embodiments of the inventive concepts;

FIG. 13 illustrates a hub device and a root device according to some example embodiments of the inventive concepts;

FIG. 14 illustrates a software configuration value according to some example embodiments of the inventive concepts;

FIG. 15 illustrates a chain message authentication code generation protocol of a parent device according to some example embodiments of the inventive concepts;

FIG. 16 is a flowchart of a method of generating a child message authentication code according to some example embodiments of the inventive concepts;

FIG. 17 is a flowchart of a method of verifying a network system according to some example embodiments of the inventive concepts;

FIG. 18 illustrates a network system according to some example embodiments of the inventive concepts;

FIG. 19 illustrates message authentication code configurations according to some example embodiments of the inventive concepts;

FIG. 20 illustrates an Internet of Things (IoT) system according to some example embodiments of the inventive concepts; and

FIG. 21 illustrates an example of a network system applied to an open space according to some example embodiments of the inventive concepts.

### DETAILED DESCRIPTION

Hereinafter, some example embodiments of the inventive concepts will be described in detail with reference to the accompanying drawings. Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, or in some cases be performed in reverse order.

Units and/or devices according to one or more example embodiments may be implemented using hardware, a combination of hardware and software, or storage media storing software. Hardware may be implemented using processing circuity such as, but not limited to, one or more processors, one or more Central Processing Units (CPUs), one or more controllers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUs), one or more microprocessors, one or more Application Specific Integrated Circuits (ASICs), or any other device or devices capable of responding to and executing instructions in a defined manner

Software may include a computer program, program code, instructions, or some combination thereof, for independently or collectively instructing or configuring a hardware device to operate as desired. The computer program and/or program code may include program or computer-readable instructions, software components, software modules, data files, data structures, etc., capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., one or more processors, CPUs, controllers, ALUs, DSPs, microcomputers, microprocessors, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor. In another example, the hardware device may be an integrated circuit customized into special purpose processing circuitry (e.g., an ASIC).

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Software and/or data may be embodied permanently or temporarily in any type of storage media including, but not limited to, any machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including tangible or non-transitory computer-readable storage media as discussed herein.

Storage media may also include one or more storage devices at units and/or devices according to one or more example embodiments. The one or more storage devices may be tangible or non-transitory computer-readable storage media, such as random access memory (RAM), read only memory (ROM), a permanent mass storage device (such as a disk drive), and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the storage media, the computer programs, program code, instructions, or some combination thereof, may be specially designed and constructed for the purposes of the example embodiments, or they may be known devices that are altered and/or modified for the purposes of example embodiments.

The above description of structural example embodiments applies similarly with regard to one or more of the hub device 100, the end node device(s) 200, the sender 1100, the receiver 1200, the key management system (KMS) 300, the root device(s) 400, the sub-tree(s) 510, the parent device(s) 600, the child device(s) 700, the end-node devices 800, 810, 900, 910, the Internet of Things (IoT) devices 2110 through 2140, the home gateway 2300, the home server 2400, the server 2600, the service provider 2700, the mobile device 2800, the communication connection device 3100, the lighting devices 3200, 3300, the server 3400, the computer 3500, the communication base station 3600, the mobile device 3800, and/or components thereof, as discussed in detail below with reference to the accompanying drawings.

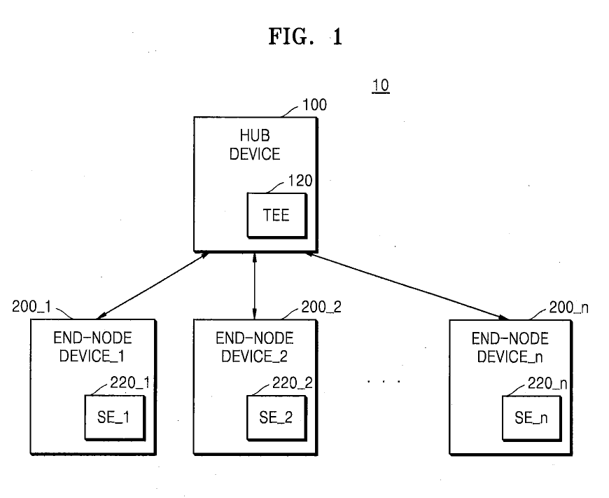

FIG. 1 illustrates a network system 10 according to some example embodiments of the inventive concepts.

The network system 10 may include a hub device 100 and first through n^{th} end-node devices 200_1 through 200_n (where n is a natural number). In addition to the case illustrated in FIG. 1, the network system 10 may include a hub device 100 and one end-node device, according to some example embodiments. The network system 10 may include any system in which the first through n^{th} end-node devices 200_1 through 200_n are connected to the hub device 100 for performing a communication operation. The hub device 100 may be referred to as a server, and in this case, the first through n^{th} end-node devices 200_1 through 200_n may be referred to as clients.

The network system 10 may include an Internet of Things (IoT) system. In this case, the first through n^{th} end-node devices 200_1 through 200_n may be IoT devices and the hub device 100 may be a router device, according to some non-limiting example embodiments. The IoT system may be referred to in various terms such as an IoT network system, a ubiquitous sensor network (USN) communication system, a machine type communications (MTC) communication system, a machine oriented communication (MOC) communication system, a machine to machine (M2M) communication system, and/or a device to device (D2D) system, for example. The IoT system may use, for communication between two or more components therein, a transport protocol such as user datagram protocol (UDP) and transmission control protocol (TCP), an IPv6 internet routing protocol, and application protocols such as constrained application protocol (CoAP), hypertext transfer protocol (HTTP), message queue telemetry transport (MQTT), and MQTT for sensors networks (MQTT-S), for example.

The hub device 100 may communicate with the first through n^{th} end-node devices 200_1 through 200_n via various network methods of exchanging various data. In addition, the hub device 100 may be connected to an external server (not illustrated) such as an Internet server. The hub device 100 may include at least one processor and a memory that stores instructions for operation of the hub device 100.

The hub device 100 may include a trusted execution environment (TEE) 120. The TEE 120 is a secure area that may reside in an application processor (not illustrated) of the hub device 100, for example. The TEE 120 is a hardware architecture combined with dedicated software that forms the basis of trust for a wide array of applications, and provides functionality related to device integrity, key management, cryptographic operations, authentication, authorization, access control, and privacy protection. The TEE 120 is separated by hardware from a main operating system of the hub device 100, and ensures the secure storage and processing of sensitive data and trusted applications. The TEE 120 may protect the integrity and confidentiality of key resources, and manage and execute trusted applications, for example. Trusted applications running in the TEE 120 have access to the main processor (CPU) and memory (not illustrated), while hardware isolation protects these trusted applications from other applications (e.g., untrusted applications, user-installed applications) running in the main operating system. Software and cryptographic isolation inside the TEE 120 protect the trusted applications contained within from each other.

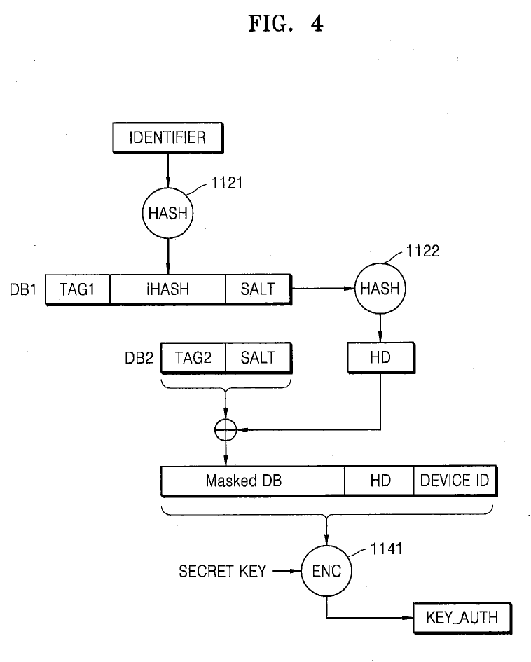

The TEE 120 may include a security area where an access to the hub device 100 from the outside is impossible. The hub device 100 may store information related to security in the TEE 120. For example, the hub device 100 may store in the TEE 120 identifiers, secret keys, and authentication keys of the first through n^{th} end-node devices 200_1 through 200_n. In a preparation phase in which the first through n^{th} end-node devices 200_1 through 200_n are connected to the hub device 100, the hub device 100 may receive authentication messages from the first through n^{th} end-node devices 200_1 through 200_n, and generate the authentication keys by using the identifiers and the secret keys based on the received authentication messages. A detailed method of generating an authentication key is described below with reference to FIG. 4.

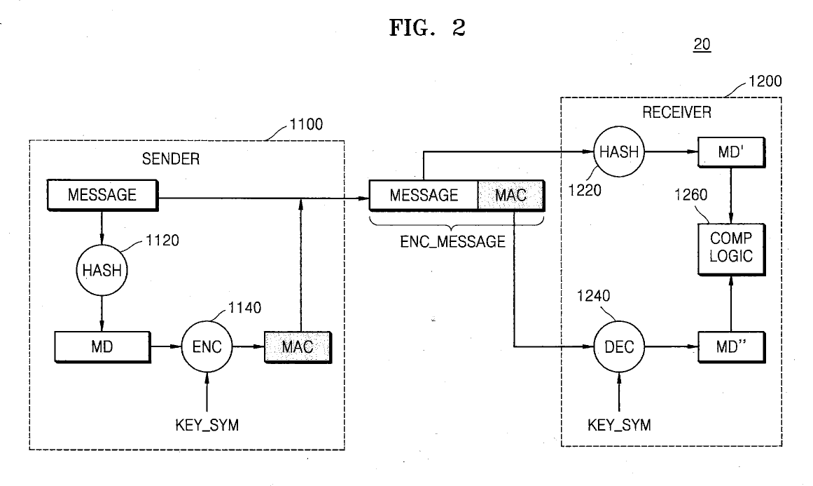

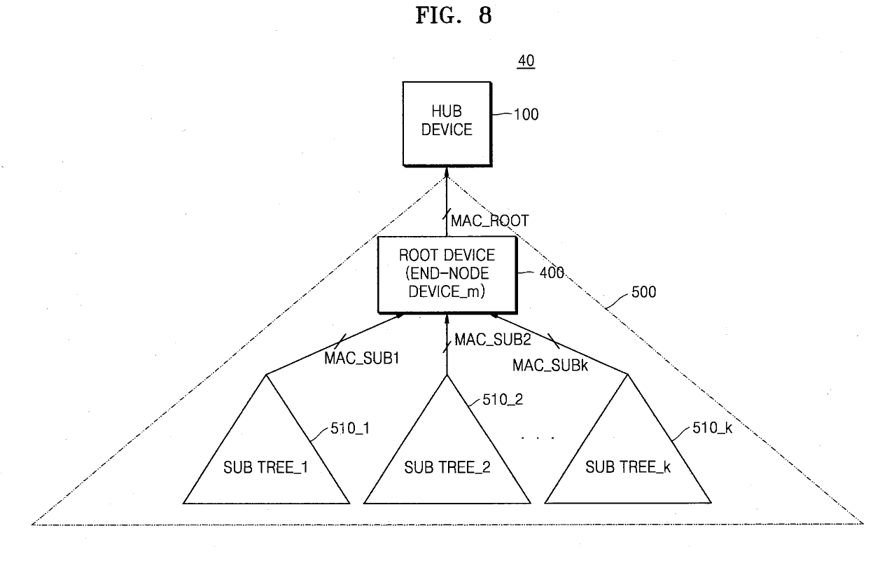

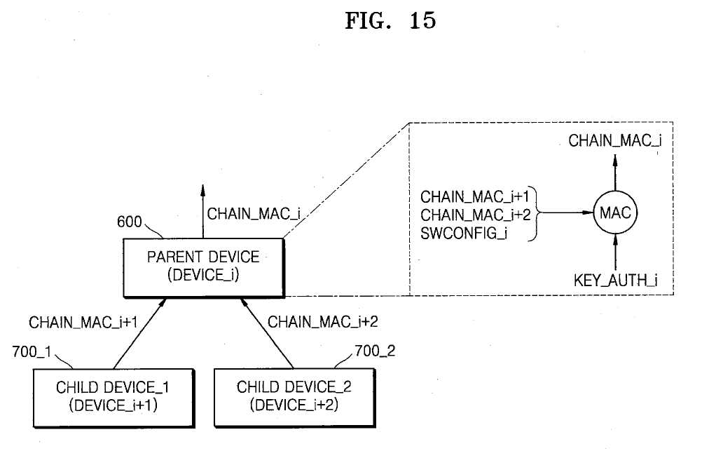

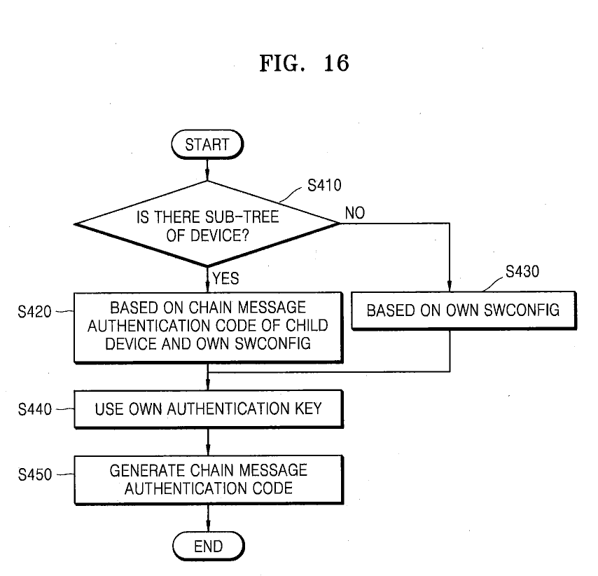

The hub device 100 may authenticate the first through n^{th} end-node devices 200_1 through 200_n and verify the integrity of the first through n^{th} end-node devices 200_1 through 200_n. The hub device 100 may simultaneously verify the integrity of the first through n^{th} end-node devices 200_1 through 200_n in a one-to-many manner, rather than in a one-to-one manner. The hub device 100 may determine a root device among the first through n^{th} end-node devices 200_1 through 200_n to verify the integrity of the first through n^{th} end-node devices 200_1 through 200_n, and may form a tree structure in which the root device is a root node. In addition, the hub device 100 may verify the integrity of the first through n^{th} end-node devices 200_1 through 200_n by using a symmetric key method. The tree structure of the first through n^{th} end-node devices 200_1 through 200_n is described with reference to FIG. 8, and a detailed operation of encryption technology using the symmetric key method is described with reference to FIG. 2. In particular, the hub device 100 may verify the integrity of the first through n^{th} end-node devices 200_1 through 200_n by using the authentication keys of the first through n^{th} end-node devices 200_1 through 200_n as symmetric keys. According to some example embodiments, software configuration values of the first through n^{th} end-node devices 200_1 through 200_n may be used to verify the integrity of the first through n^{th} end-node devices 200_1 through 200_n, and a chain message authentication code may also be used for integrity verification. The chain message authentication code is described below with reference to FIGS. 15 and 16.

The first through n^{th} end-node devices 200_1 through 200_n may communicate with the hub device 100 and/or with each other via a wired/wireless interface. The wired/wireless interface may include modem communication interfaces that are connectable to a wired local area network (LAN), a wireless local area network (WLAN) such as a wireless fidelity (WiFi), a wireless personal area network (WPAN) such as Bluetooth, wireless universal serial bus (USB), ZigBee, near field communication (NFC), radio frequency identification (RFID), power line communication (PLC), and a mobile cellular network such as 3rd generation (3G), 4th generation (4G), and long term evolution (LTE), for example. Each of the first through n^{th} end-node devices 200_1 through 200_n may share software configuration values through communication with other end-node devices.

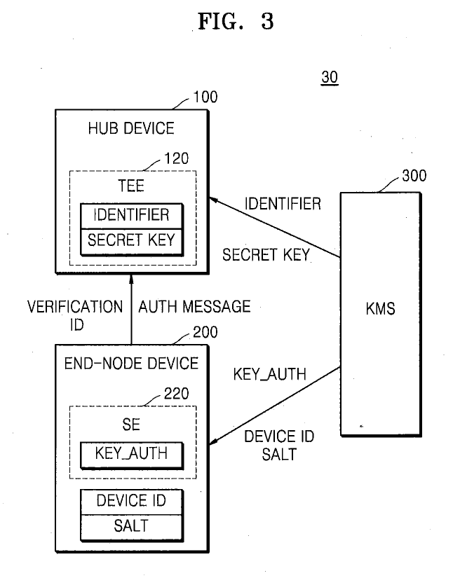

The first through n^{th} end-node devices 200_1 through 200_n may include first through n^{th} security elements (SE_1 through SE_n) 220_1 through 220_n, respectively. Each of the first through n^{th} security elements 220_1 through 220_n may include a storage space accessible only by an authenticated user. The first through n^{th} end-node devices 200_1 through 200_n may store data requiring a high security level in the first through n^{th} security elements 220_1 through 220_n to maintain security from external threats. For example, the first through n^{th} end-node devices 200_1 through 200_n may store the authentication keys in the first through n^{th} security elements 220_1 through 220_n, respectively. Non-limiting example embodiments of structure and functionality of the first through n^{th} security elements 220_1 through 220_n will be discussed further below in connection with the security element 220 of FIG. 3.

Each of the first through n^{th} end-node devices 200_1 through 200_n may be an IoT device and may include, for example, an active IoT device that operates by using its own power and a passive IoT device that operates by power wirelessly applied from the outside. The active IoT devices may include refrigerators, air conditioners, telephones, automobiles, etc., and the passive IoT devices may include RFID tags or NFC tags, for example.

FIG. 2 illustrates a protocol 20 of encryption technology using the symmetric key according to some example embodiments of the inventive concepts.

Encryption technology may include encryption technology using a symmetric key and encryption technology using asymmetric keys. In symmetric encryption technology, an encryption key used for encrypting a message MESSAGE at a sender 1100 sending the message MESSAGE is the same as a decryption key used for decrypting the message MESSAGE at a receiver 1200 receiving the message MESSAGE. In asymmetric encryption technology, an encryption key used by the sender 1100 is different from a decryption key used by the receiver 1200. In asymmetric encryption technology, the encryption key may be referred to as a public key and the decryption key may be referred to as a private key. Asymmetric encryption technology may include complicated, resource-intensive operations and thus, when resources of a device using asymmetric encryption technology are limited (e.g., resource-constrained mobile devices and/or IoT devices having limited available memory, processing capabilities, battery power, etc.), it may take a relatively long time to perform the asymmetric encryption and/or decryption operations. On the other hand, symmetric encryption technology may include relatively less complicated operations consuming fewer resources, such that the resource-constrained device may perform the symmetric encryption and/or decryption operations in a relatively shorter amount of time as compared to asymmetric encryption technology.

Referring to FIG. 2, the sender 1100 may encrypt the message MESSAGE by using a symmetric key KEY_SYM and transmit an encrypted message ENC_MESSAGE to the receiver 1200. The receiver 1200 may receive the encrypted message ENC_MESSAGE and verify the integrity of the message MESSAGE by using the symmetric key KEY_SYM to decrypt the encrypted message ENC_MESSAGE.

The sender 1100 may generate a message digest MD from the message MESSAGE by using a hash function (HASH) 1120. The HASH 1120 may include various functions that generate outputs having the same size regardless of a size of input data and there may be no reverse function. The HASH 1120 may include secure hash algorithms such as SHA-128, SHA-256, and SHA-512, as non-limiting examples. The sender 1100 may generate a message authentication code MAC from the message digest MD by using an encryption operation (ENC) 1140. The ENC 1140 may be performed by using the symmetric key KEY_SYM. The sender 1100 may generate the encrypted message ENC_MESSAGE based on the message MESSAGE and the message authentication code MAC. Referring to FIG. 2, the encrypted message ENC_MESSAGE may have a form in which the message authentication code MAC is behind the message MESSAGE, but is not limited thereto. For example, the encrypted message ENC_MESSAGE may be in a form of the message MESSAGE followed by the message authentication code MAC.

The receiver 1200 may include a comparison logic (COMP LOGIC) 1260 and may receive the encrypted message ENC_MESSAGE from the sender 1100. The receiver 1200 may separate the message MESSAGE and the message authentication code MAC from the encrypted message ENC_MESSAGE. The receiver 1200 may generate a first message digest MD′ from the message MESSAGE by using a HASH 1220. The receiver 1200 may generate a second message digest MD″ from the message authentication code MAC by using a decryption operation (DEC) 1240. The DEC 1240 may be performed by using the symmetric key KEY_SYM. The COMP LOGIC 1260 may verify the integrity of the encrypted message ENC_MESSAGE received from the sender 1100 by comparing the first message digest MD′ with the second message digest MD″. For example, when the first message digest MD′ is different from the second message digest MD″, at least one of the message MESSAGE and the message authentication code MAC may have been attacked by malicious software from the outside. The malicious software may be referred to as malware, and non-limiting examples of malware may include computer viruses, worms, Trojan horses, spyware, dishware, adware, scareware, crimeware, and other malicious software or programs.

For convenience of description in the following figures, a step of forming the message authentication code MAC at the sender 1100 may be referred to as a MAC operation, and a step of verifying the integrity of the message MESSAGE by using the message MESSAGE and the message authentication code MAC at the receiver 1200 may be referred to as a VERMAC operation. In addition, a method disclosed in FIG. 2 of generating a message authentication code MAC by using the symmetric key KEY_SYM and verifying the integrity of the message MESSAGE by using the symmetric key KEY_SYM is merely a non-limiting example, and various methods of encryption may be applied according to some example embodiments.

FIG. 3 illustrates a network authentication system 30 according to some example embodiments of the inventive concepts.

The network authentication system 30 may include a hub device 100, an end-node device 200, and a key management system (KMS) 300. Referring to FIG. 3, the network authentication system 30 may include one end-node device 200, but this case is only a non-limiting example for convenience of description, and the network authentication system 30 may include a plurality of end-node devices 200. Descriptions of the hub device 100 and the end-node device 200 that are the same as those given with reference to FIG. 1 will be omitted.

The KMS 300 may generate a salt, a device ID, an identifier, and a secret key of the end-node device 200. In addition, the KMS 300 may generate an authentication key KEY_AUTH of the end-node device 200 by using the salt, the device ID, the identifier, and the secret key. The salt may be data having a certain number of bits arbitrarily generated by the KMS 300. The KMS 300 may transmit the identifier and the secret key to the hub device 100 and may transmit the salt, the device ID, and the authentication key KEY_AUTH to the end-node device 200. Thus, the authentication key KEY_AUTH may be stored in the end-node device 200 in advance, according to some example embodiments.

The hub device 100 may include a TEE 120. The TEE 120 may store the identifier and the secret key received from the KMS 300. Since the TEE 120 is not accessible from the outside, an external intruder such as malware cannot access the identifier and the secret key.

The end-node device 200 may include a security element (SE) 220, such as in the form of an embedded, tamper-resistant security chip, a secure integrated circuit (IC), an application specific integrated circuit (ASIC), a hardware security module (HSM), etc. Dedicated software for the security element 220 supports various tasks such as personal verification, device authentication, security key and sensitive data storage, cryptographic operations, encoding and decoding, etc., and allows key and authentication information to be safely transferred between devices, servers, and clouds, for example. The security element 220 may store the authentication key KEY_AUTH received from the KMS 300. Since the security element 220 is an area with enhanced security in the end-node device 200, the authentication key KEY_AUTH is not accessible from the outside. The end-node device 200 may store the device ID and the salt separately from the authentication key KEY_AUTH (e.g., in a memory separate from the security element 220), according to some example embodiments. Other non-limiting example embodiments of end-node devices discussed herein (e.g., the sender 1100, the receiver 1200, the root device(s) 400, the sub-tree(s) 510, the parent device(s) 600, the child device(s) 700, the end-node devices 800, 810, 900, 910, the IoT devices 2110 through 2140, the mobile devices 2800, 3800, etc.) may also include a security element 220.

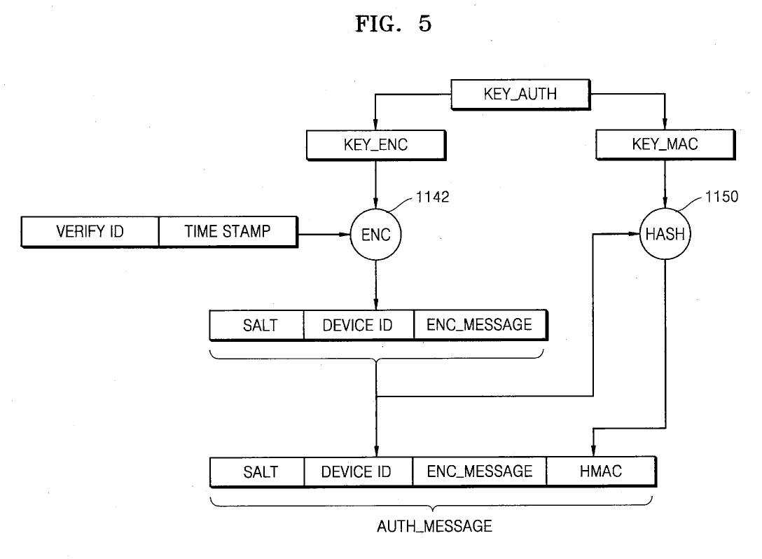

The end-node device 200 may transmit a verification ID to the hub device 100 for device authentication and transmit an authentication message AUTH_MESSAGE for authentication to the hub device 100. The end-node device 200 may generate the authentication message AUTH_MESSAGE by using the device ID, the salt, and the authentication key KEY_AUTH. A method of generating the AUTH _MESSAGE of the end-node device 200 is described below with reference to FIG. 5.

The hub device 100 may receive the authentication message AUTH_{—} MESSAGE for authentication of the end-node device 200. The hub device 100 may authenticate the end-node device 200 by using the verification ID and the authentication message AUTH_MESSAGE, which may be received from the end-node device 200 in advance. In addition, the hub device 100 may generate the authentication key KEY_AUTH by using the identifier, the secret key, and the authentication message AUTH_MESSAGE, which are stored in the TEE 120. For example, the hub device 100 may separate the salt and the device ID from the authentication message AUTH_MESSAGE received from the end-node device 200, thereby generating the authentication key KEY_AUTH of the end-node device 200. A method of generating the authentication key KEY_AUTH of the hub device 100 is described below with reference to FIG. 4. The hub device 100 may use the authentication key KEY_AUTH as a symmetric key when verifying the integrity of the end-node device 200. For example, the end-node device 200 may use the authentication key KEY_AUTH as the symmetric key to encrypt specific information and transmit the message authentication code MAC to the hub device 100, and the hub device 100 may verify the received message authentication code MAC by using the authentication key KEY_AUTH of the end-node device 200 for decryption. Accordingly, the hub device 100 and the end-node device 200 may share the symmetric key indirectly via the authentication message AUTH_MESSAGE, without direct sharing of the symmetric key, and thus, a risk that the symmetric key is exposed to the outside may be reduced or prevented.

FIG. 4 illustrates an authentication key generation protocol according to some example embodiments of the inventive concepts. Generation of the authentication key KEY_AUTH may be performed by the hub device 100 and the KMS 300 in FIG. 3. Hereinafter, for convenience of description, it is assumed that the authentication key generation protocol of FIG. 4 is performed by the hub device 100. A process of generating the authentication key KEY_AUTH by the KMS 300 may also be understood to be the same as the following process.

The hub device 100 may generate an iHASH from the identifier by using a HASH 1121. The hub device 100 may generate a first data block DB1 by using a first tag TAG1, the iHASH, and the salt. The hub device 100 may generate a second data block DB2 by using a second tag TAG2 and the salt, and generate a hash data block HD from the first data block DB1 by using a HASH 1122. The first tag TAG1 and the second tag TAG2 may be arbitrary data having a certain number of bits. The hub device 100 may generate a masked data block (DB) from the second data block DB2 and the hash data block HD by performing an XOR operation. The hub device 100 may generate the authentication key KEY_AUTH from a message containing the masked DB, the hash data block HD, and the device ID by using an ENC 1141. The ENC 1141 may be performed by using the secret key stored in the TEE 120.

Thus, the hub device 100 and the KMS 300 of FIG. 3 may generate the authentication key KEY_AUTH by using the identifier, the salt, the device ID, and the secret key. Regarding a method of generating the authentication key KEY_AUTH illustrated in FIG. 4, a method of configuring data blocks by using various data is not limited to an order illustrated in FIG. 4, and the order of data in the configuring of data blocks may be changed according to some example embodiments.

FIG. 5 illustrates an authentication message AUTH_MESSAGE generation protocol according to some example embodiments of the inventive concepts. The authentication message AUTH_MESSAGE may be generated by the end-node device 200 in FIG. 3.

The end-node device 200 may receive the authentication key KEY_AUTH from the KMS 300 in advance and store the received authentication key KEY_AUTH in the security element 220 (e.g., the security chip). The authentication key KEY_AUTH may include an encryption key KEY_ENC and a message authentication code key KEY_MAC. The end-node device 200 may perform an ENC 1142 by using the encryption key KEY_ENC based on the verification ID and a time stamp to generate the encrypted message ENC_MESSAGE. The end-node device 200 may perform a HASH 1150 by using the MAC key KEY_MAC based on the salt, the device ID, and the encrypted message ENC_MESSAGE, thereby generating a hash message authentication code HMAC. The end-node device 200 may generate the authentication message AUTH_MESSAGE by using the salt, the device ID, the encrypted message ENC_MESSAGE, and the hash message authentication code HMAC.

Thus, the end-node device 200 in FIG. 3 may generate the authentication message AUTH_MESSAGE by using the salt, the device ID, and the authentication key KEY_AUTH. Regarding a method of generating the authentication message AUTH_MESSAGE illustrated in FIG. 5, a method of configuring data blocks by using various data is not limited to an order illustrated in FIG. 5, and the order of data in the configuring of data blocks may be changed according to some example embodiments.

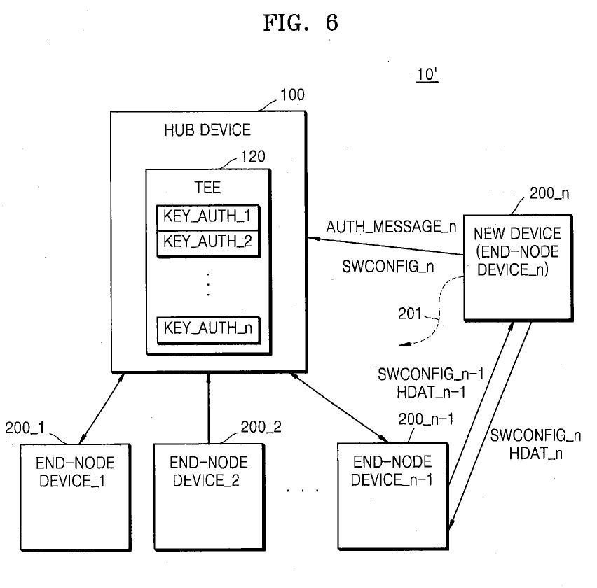

FIG. 6 illustrates a network system 10′ according to some example embodiments of the inventive concepts. The network system 10′ may include the hub device 100 and the first through n^{th} end-node devices 200_1 through 200_n. Descriptions of the hub device 100 and the end-node devices 200 that are the same as those given with reference to FIG. 1 will be omitted. FIG. 6 illustrates a preparation phase in which an n^{th} end-node device 200_n is added to the existing network system 10′ including (n−1) of first through (n−1)^{th} end-node devices 200_1 through 200_n−1.

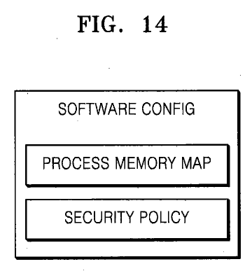

In the preparation phase, the n^{th} end-node device 200_n may be connected to the hub device 100 and may perform a communication operation. The hub device 100 may receive an n^{th} authentication message AUTH_MESSAGE_n to authenticate the nth end-node device 200_n. The hub device 100 may generate an n^{th} authentication key KEY_AUTH_n by using an n^{th} identifier, an n^{th} device ID, and the n^{th} authentication message AUTH_MESSAGE_n in the same manner as described with reference to FIG. 4. The hub device 100 may store the n^{th} authentication key KEY_AUTH_n in the TEE 120. The n^{th} end-node device 200_n may transmit an n^{th} software configuration value SWCONFIG_n thereof to the hub device 100. The n^{th} software configuration value SWCONFIG_n may include process memory map information of the n^{th} end-node device 200_n and security policy information of the n^{th} end-node device 200_n. More detailed description of the n^{th} software configuration value SWCONFIG_n may be understood with reference to FIG. 14.

In the preparation phase, the n^{th} end-node device 200_n may communicate with the existing first through (n−1)^{th} end-node devices 200_1 through 200_n−1. For example, in the preparation phase, the nth end-node device 200_n may transmit to the (n−1)^{th} end-node device 200_n−1 the n^{th} software configuration value SWCONFIG_n and n^{th} hash data HDAT_n for generating a hash key of the n^{th} end-node device 200_n. In addition, for example, in the preparation phase, the (n−1)^{th} end-node device 200_n−1 may transmit to the n^{th} end-node device 200_n the (n−1)^{th} software configuration value SWCONFIG_n−1 and (n−1)^{th} hash data HDAT_n−1 for generating a hash key of the (n−1)^{th} end-node device 200_n−1. Thus, the first through n^{th} end-node devices 200_1 to 200_n may share their software configuration values SWCONFIG_1 through SWCONFIG_n, and may generate and store hash keys between end-node devices according to the following description. Since all of the software configuration values SWCONFIG_1 through SWCONFIG_n are shared by all of the first through n^{th} end-node devices 200_1 through 200_n, integrity verification of the network system 10′ may be more powerful and/or robust.

In the preparation phase, the n^{th} end-node device 200_n may generate the hash key in a mutual relationship with the existing first through n^{th} end-node devices 200_1 through 200_n−1. For example, in the preparation phase, the n^{th} end-node device 200_n may generate the hash key with the (n−1)^{th} end-node device 200_n−1. As described above, the n^{th} end-node device 200_n may receive the (n−1)^{th} hash data HDAT_n−1 from the (n−1)^{th} end-node device 200_n−1, and the (n−1)^{th} end-node device 200_n−1 may receive the n^{th} hash data HDAT_n from the n^{th} end-node device 200_n. Thus, the (n−1)^{th} end-node device 200_n−1 and the nth end-node device 200_n may share the (n−1)^{th} hash data HDAT_n−1 and the n^{th} hash data HDAT_n. The (n- 1)^{th} and n^{th} end-node devices 200_n−1 and 200_n may generate the hash key therebetween from the shared (n−1)^{th} and n^{th} hash data HDAT_n−1 and HDAT_n.

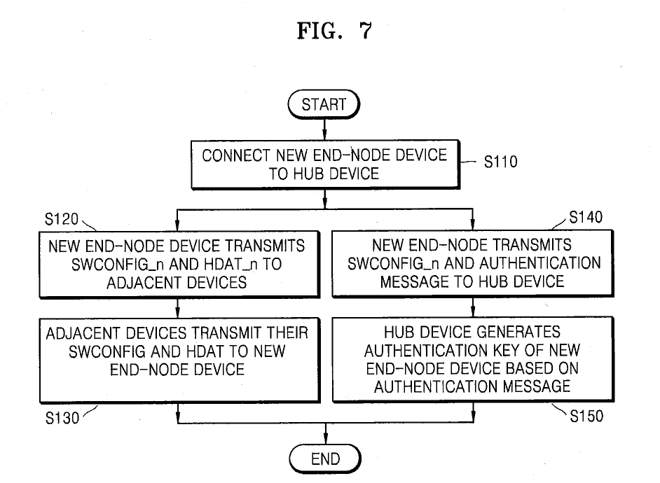

FIG. 7 is a flowchart of a network preparation phase according to some example embodiments of the inventive concepts.

In the network preparation phase, a new end-node device, for example, an n^{th} end-node device DEVICE_n, may be newly connected to a hub device (S110).

The new end-node device may exchange data with existing adjacent end-node devices through a communication operation. The new end-node device may transmit to the adjacent end-node devices the n^{th} software configuration value SWCONFIG_n and the n^{th} hash data HDAT_n for generating a hash key (S120). Each adjacent end-node device may deliver to the new end-node device a software configuration value SWCONFIG thereof and hash data HDAT for mutual hash key generation (S130).

The new end-node device may transmit to the hub device an n^{th} authentication message and an n^{th} software configuration value SWCONFIG_n (S140). The hub device may generate an n^{th} authentication key of the new end-node device (the n^{th} end-node device) based on the received nth authentication message, as described with reference to FIG. 4 (S150).

FIG. 8 illustrates a network system 40 according to some example embodiments of the inventive concepts. The network system 40 may include the hub device 100 and a plurality of end-node devices, including a root device 400 and first through k^{th} sub-trees 510_1 through 510_k. Descriptions of the hub device 100, the root device 400, and the first through k^{th} sub-trees 510_1 through 510_k that are the same as those given with reference to FIG. 1 will be omitted. In particular, FIG. 8 illustrates the network system 40 in an integrity verification phase that verifies integrity of the root device 400 and the first through k^{th} sub-trees 510_1 through 510_k. The network system 40 may periodically enter the integrity verification phase according to a certain period of time. However, some example embodiments are not limited thereto. For example, the network system 40 may enter the integrity verification phase via a trigger from outside the network system 40.

The hub device 100 may arbitrarily determine the root device 400 as a root node among the root device 400 and the first through k^{th} sub-trees 510_1 through 510_k in the integrity verification phase. The root device 400 may be a different device for each integrity verification phase, or may be an identical device, according to some example embodiments. For convenience of description below, the root device 400 is described as being an m^{th} end-node device, but is not limited thereto.

The hub device 100 may form a tree structure 500 that uses the root device 400 and the first through k^{th} sub-trees 510_1 through 510_k to choose the root device 400 as a root node. The tree structure 500 may include a binary tree structure. The hub device 100 may form the tree structure 500 differently for each integrity verification phase, according to some example embodiments. The tree structure 500 may include a plurality of top-node devices and bottom-node devices which are connected in a line in pairs, wherein the top-node device is referred to as a parent device and the bottom-node device is referred to as a child device. In other words, the tree structure 500 may include k sub-trees 510_1 through 510_k (where k is a natural number) having the root device 400 as the parent device.

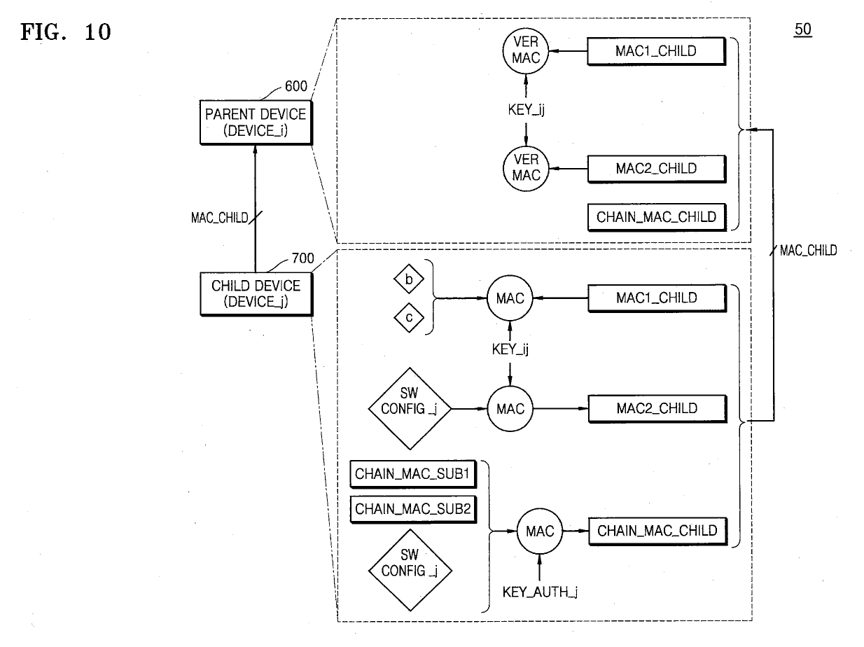

The root device 400 may receive sub-tree message authentication codes MAC_SUB1 through MAC_SUBk from the first through k^{th} sub-trees 510_1 through 510_k of the root device 400. The root device 400 may verify the integrity of the first through k^{th} sub-trees 510_1 through 510_k of the root device 400 based on the received sub-tree message authentication codes MAC_SUB1 through MAC_SUBk. The sub-trees 510_1 through 510_k of the root device 400 may generate the sub-tree message authentication codes MAC_SUB1 through MAC_SUBk based on a result of the integrity verification of the sub-trees of respective root nodes of the first through k^{th} sub-trees 510_1 through 510_k. As a result, a step of verifying the integrity of the first through k^{th} sub-trees 510_1 through 510_k of the root device 400 by the root device 400 may include a plurality of verification loops between the parent devices and the child devices. The verification loop is described below with reference to FIGS. 10 through 12.

The root device 400 may generate a root message authentication code MAC_ROOT by using an authentication key of the root device 400 based on the result of the integrity verification of the first through k^{th} sub-trees 510_1 through 510_k of the root device 400 and a software configuration value of the root device 400. The root device 400 may transmit the root message authentication code MAC_ROOT to the hub device 100 for verification.

The hub device 100 may verify the received root message authentication code MAC_ROOT. The hub device 100 may verify the integrity of the whole tree structure 500 including the root device 400 and the first through k^{th} sub-trees 510_1 through 510_k by verifying the root message authentication code MAC_ROOT.

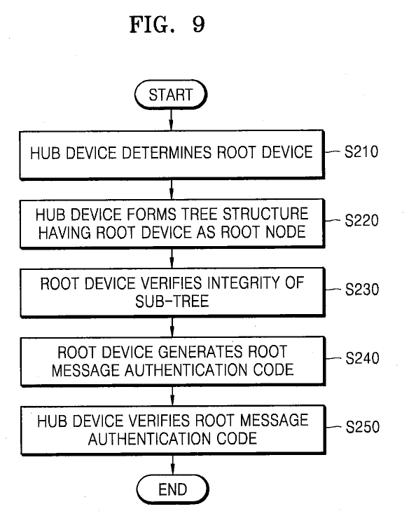

FIG. 9 is a flowchart of a method of verifying integrity of a network according to some example embodiments of the inventive concepts. The flowchart of the method of verifying the integrity of the network of FIG. 9 is described with reference to the network system 40 of FIG. 8.

The hub device 100 may arbitrarily determine the root device 400 among the plurality of end-node devices including the root device 400 and the first through k^{th} sub-trees 510_1 through 510_k in the integrity verification phase (S210). The hub device 100 may form the tree structure 500 that uses the root device 400 and the first through k^{th} sub-trees 510_1 through 510_k to choose the root device 400 as a root node (S220). The root device 400 may verify the integrity of the first through k^{th} sub-trees 510_1 through 510_k of the root device 400 (S230). The root device 400 may generate the root message authentication code MAC_ROOT based on a result of the integrity verification of the first through k^{th} sub-trees 510_1 through 510_k of the root device 400 (S240). The root device 400 may transmit the root message authentication code MAC_ROOT to the hub device 100 for verification. The hub device 100 may verify the received root message authentication code MAC_ROOT (S250). Thus, the hub device 100 may form the tree structure 500 by using the root device 400 and the first through k^{th} sub-trees 510_1 through 510_k such that all of the root device 400 and the first through k^{th} sub-trees 510_1 through 510_k may be verified only by verifying the root message authentication code MAC_ROOT.

FIG. 10 illustrates a parent-child system 50 according to some example embodiments of the inventive concepts. The parent-child system 50 may include a parent device 600 and a child device 700. For convenience of description, the parent device 600 is referred to as an i^{th} end-node device and the child device 700 is referred to as a j^{th} end-node device, but some example embodiments are not limited thereto. A relationship between the parent device 600 and the child device 700 may represent a relative (e.g., hierarchical) relationship between the top-node device and the bottom-node device in the tree structure 500 in FIG. 8, which may be applied to the tree structure 500 and the first through k^{th} sub-trees 510_1 through 510_k in FIG. 8.

The child device 700 may transmit at least one child message authentication code MAC_CHILD to the parent device 600. The at least one child message authentication code MAC_CHILD may include a first child message authentication code MAC1_CHILD and a second child message authentication code MAC2_CHILD. However, some example embodiments are not limited thereto. For example, the child message authentication code MAC_CHILD may further include a child chain message authentication code CHAIN_MAC_CHILD. The child device 700 may generate the first child message authentication code MAC1_CHILD by using a hash key KEY_ij based on values of b and c, where b may represent the number of end-node devices of which integrities are verified among the end-node devices included in the sub-trees of the child device 700, and c may represent the total number of end-node devices included in the sub-trees of the child device 700. For example, when the child device 700 corresponds to a leaf-node that does not include a sub-tree, b and c of the child device 700 may have a value of 0. The child device 700 may determine a value of b based on a result of the integrity verification of the sub-trees of the child device 700.

The child device 700 may generate the second child message authentication code MAC2_CHILD by using the hash key KEY_ij based on a j^{th} software configuration value SWCONFIG_j of the child device 700. The j^{th} software configuration value SWCONFIG_j may include process memory map information and security policy information of the child device 700. More detailed description thereof may be understood with reference to FIG. 14.

The child device 700 may generate the child chain message authentication code CHAIN_MAC_CHILD by using a j^{th} authentication key KEY_AUTH_j based on sub-tree chain message authentication codes CHAIN_MAC_SUB1 and CHAIN_MAC_SUB2 of the child device 700 and the j^{th} software configuration value SWCONFIG_j of the child device 700. More detailed description of the chain message authentication code may be understood with reference to FIGS. 15 and 16.

The parent device 600 may verify the first child message authentication code MAC1_CHILD received from the child device 700 by using the hash key KEY_ij. The parent device 600 may receive values of b and c from the child device 700 to verify the first child message authentication code MAC1_CHILD. The parent device 600 may compare a first comparison message authentication code generated by using the hash key KEY_ij based on the received values of b and c, with the received first child message authentication code MAC1_CHILD, thereby verifying the first child message authentication code MAC1_CHILD. For example, if the first child message authentication code MAC1_CHILD matches the first comparison message authentication code, verification of the first child message authentication code MAC1_CHILD is successful.

The parent device 600 may verify the second child message authentication code MAC2_CHILD received from the child device 700 by using the hash key KEY_ij. The parent device 600 may compare a second comparison message authentication code generated by using the hash key KEY_ij based on the j^{th} software configuration value SWCONFIG_j stored therein, with the received second child message authentication code MAC2_CHILD, thereby verifying the second child message authentication code MAC2_CHILD. For example, if the second child message authentication code MAC2_CHILD matches the second comparison message authentication code, verification of the second child message authentication code MAC2_CHILD is successful.

A result of verifying the first and second child message authentication codes MAC1_CHILD and MAC2_CHILD may be used to determine the value of b of the parent device 600, and the received chain child message authentication code CHAIN_MAC_CHILD may be used to generate a parent chain message authentication code of the parent device 600.

Information used for generating the first and second child message authentication codes MAC1_CHILD and MAC2_CHILD described above is a non-limiting example, and some example embodiments are not limited thereto. For example, when the child device 700 generates the first and second child message authentication codes MAC1_CHILD and MAC2_CHILD, the child device 700 may additionally use values of N (not illustrated) and q (not illustrated) for security enhancement, where N may be data arbitrarily determined between devices in the integrity verification phase, and q may be data arbitrarily determined in the whole network system.

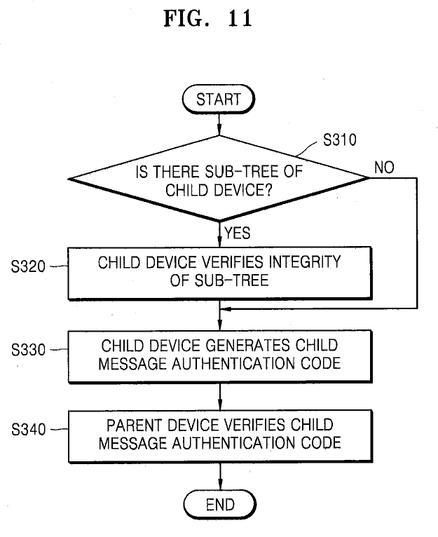

FIG. 11 is a flowchart of a verification loop according to some example embodiments of the inventive concepts. FIG. 11 is described with reference to the parent-child system 50 of FIG. 10.

Firstly, whether the child device 700 includes a sub-tree may be determined (S310). When the child device 700 corresponds to a leaf node that does not include a sub-tree, the process may proceed to a step of generating a child message authentication code MAC_CHILD (S330). Otherwise, when the child device 700 includes a sub-tree, the child device 700 may verify the integrity of the sub-tree(s) of the child device 700 (S320). The child device 700 may generate at least one child message authentication code MAC_CHILD based on a result of the integrity verification of the sub-tree(s) and the j^{th} software configuration value SWCONFIG_j of the child device 700 (S330). The child device 700 may transmit at least one child message authentication code MAC_CHILD to the parent device 600. The parent device 600 may verify the at least one child message authentication code MAC_CHILD received thereby (S340).

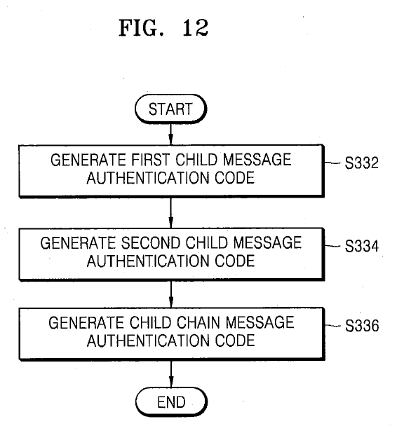

FIG. 12 is a flowchart of a method of generating a child message authentication code according to some example embodiments of the inventive concepts. FIG. 12 is described with reference to the parent-child system 50 of FIG. 10 and the step of generating the at least one child message authentication code MAC_CHILD of FIG. 11 (S330).

The child device 700 may generate the first child message authentication code MAC1_CHILD by using the hash key KEY_ij based on the values of b and c (S332). The child device 700 may generate the second child message authentication code MAC2_CHILD by using the hash key KEY_ij based on the j^{th} software configuration value SWCONFIG_j of the child device 700 (S334). The child device 700 may generate the child chain message authentication code CHAIN_MAC_CHILD by using a j^{th} authentication key KEY_AUTH_j based on the first and second sub-tree chain message authentication codes CHAIN_MAC_SUB1 and CHAIN_MAC_SUB2 of the child device 700 and the j^{th} software configuration value SWCONFIG_j of the child device 700.

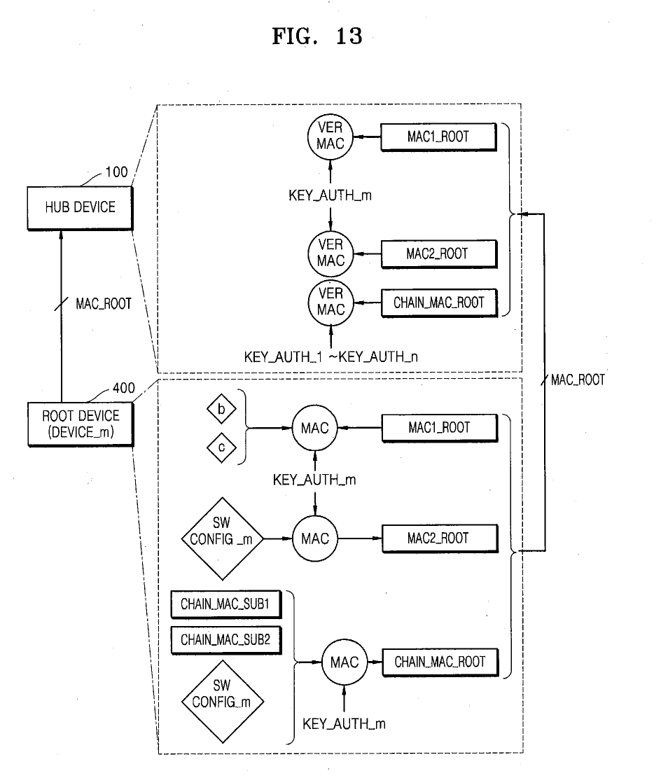

FIG. 13 illustrates the hub device 100 and the root device 400 according to some example embodiments of the inventive concepts. For convenience of description, it is assumed that the root device 400 is the m^{th} end-node device.

The root device 400 may transmit at least one root message authentication code MAC_ROOT to the hub device 100. The at least one root message authentication code MAC_ROOT may include first and second root message authentication codes MAC1_ROOT and MAC2_ROOT. However, some example embodiments are not limited thereto. For example, the root message authentication code MAC_ROOT may further include a root chain message authentication code CHAIN_MAC_ROOT.

The root device 400 may generate the first root message authentication code MAC1_ROOT by using an m^{th} authentication key KEY_AUTH_m based on values of b and c, where b may represent the number of end-node devices of which integrities are verified among the end-node devices included in the sub-trees of the root device 400, and c may represent the total number of end-node devices included in the sub-trees of the root device 400. The root device 400 may determine the value of b based on a result of the integrity verification of the sub-trees of the root device 400.

The root device 400 may generate the second root message authentication code MAC2_ROOT by using the m^{th} authentication key KEY_AUTH_m based on an m^{th} software configuration value SWCONFIG_m of the root device 400. The m^{th} software configuration value SWCONFIG_m may include process memory map information and security policy information of the root device 400. More detailed description thereof may be understood with reference to FIG. 14.

The root device 400 may generate the root chain message authentication code CHAIN_MAC_ROOT by using the m^{th} authentication key KEY_AUTH_m based on first and second sub-tree chain message authentication codes CHAIN_MAC_SUB1 and CHAIN_MAC_SUB2 of the sub-trees of the root device 400 and the m^{th} software configuration value SWCONFIG_m of the root device 400. More detailed description of the chain message authentication code may be understood with reference to FIGS. 15 and 16.

The hub device 100 may verify the first and second root message authentication codes MAC1_ROOT and MAC2_ROOT received from the root device 400 by using the m^{th} authentication key KEY_AUTH_m. In addition, the hub device 100 may verify the root chain message authentication code CHAIN_MAC_ROOT by using the authentication keys KEY_AUTH_1 through KEY_AUTH_n and the software configuration values SWCONFIG_1 through SWCONFIG_n of the plurality of end-node devices device_1 through device_n. The hub device 100 may enhance security by using the plurality of authentication keys KEY_AUTH_1 through KEY_AUTH_n as symmetric keys, thereby reducing an amount of computations, and by using various message authentication codes.

Information used for generating the first and second root message authentication codes MAC1_ROOT and MAC2_ROOT described above is only a non-limiting example, and some example embodiments are not limited thereto. For example, when the root device 400 generates the first and second root message authentication codes MAC1_ROOT and MAC2_ROOT, the root device 400 may additionally use values of N (not illustrated) and q (not illustrated) to enhance security, where N may be data arbitrarily determined between devices in the integrity verification phase, and q may be data arbitrarily determined in the whole network system.

FIG. 14 illustrates a software configuration value according to some example embodiments of the inventive concepts. The software configuration value may include various values indicating a state of an end-node device and may be utilized for the integrity verification of the end-node device. The software configuration value may include the process memory map information and the security policy information.

The process memory map information may include information about a code area on a memory of the end-node device and information about system executable files. As a non-limiting example, the process memory map information may include information about files in /bin/, /sbin/, /usr/bin/, /usr/sbin/ in a Linux system.

The security policy information may include configuration information about system configuration files and configuration information about a memory protection scheme. As a non-limiting example, configuration information about system configuration files may include at least one of network configuration information, secure shell (SSH) configuration information, and file system information. As a non-limiting example, configuration information about a memory protection scheme may include at least one of address space layout randomization (ASLR), data execution prevention (DEP), ASCII-ARMOR, and stack canary.

FIG. 15 illustrates a chain message authentication code CHAIN_MAC_i generation protocol of the parent device 600 according to some example embodiments of the inventive concepts. For convenience of description, the parent device 600 may be an i^{th} end-node device DEVICE_i, a first child device 700_1 may be an (i+1)^{th} end-node device DEVICE_i+1, and a second child device 700_2 may be an (i+2)^{th} end-node device DEVICE_i+2.

The first child device 700_1 and the second child device 700_2 may respectively transmit at least one message authentication code to the parent device 600. The at least one message authentication code may include a chain message authentication code. That is, the first child device 700_1 may transmit an (i+1)^{th} chain message authentication code CHAIN_MAC_(i+1) to the parent device 600 and the second child device 700_2 may transmit an (i+2)^{th} chain message authentication code CHAIN_MAC_(i+2) to the parent device 600.

The parent device 600 may generate an i^{th} chain message authentication code CHAIN_MAC_i by using an i^{th} authentication key KEY_AUTH_i based on the received (i+1)^{th} and (i+2)^{th} chain message authentication codes CHAIN_MAC_i+1 and CHAIN_MAC_i+2, and an i^{th} software configuration value SWCONFIG_i of the parent device 600. When the parent device 600 corresponds to a leaf node that does not include a child device, the parent device 600 may generate the i^{th} chain message authentication code CHAIN_MAC_i based on only the i^{th} software configuration value SWCONFIG_i. When the parent device 600 is the root device 400 of FIG. 13, for example, the parent device 600 may transmit the i^{th} chain message authentication code CHAIN_MAC_i to the hub device 100 for verification.

Referring to FIGS. 13 and 15, when the parent device 600 is the root device 400, the i^{th} chain message authentication code CHAIN_MAC_i may be the root chain message authentication code CHAIN_MAC_ROOT. Since the hub device 100 stores information about authentication keys KEY_AUTH_1 through KEY_AUTH_n of the plurality of end-node devices, software configuration values of the plurality of end-node devices, and information about the tree structure, the hub device 100 may generate a comparison chain message. The hub device 100 may compare the generated comparison chain message with the root chain message authentication code CHAIN_MAC_ROOT received from the root device 400 to determine whether they are identical, thereby performing the verification of the root chain message authentication code CHAIN_MAC_ROOT. For example, if the root chain message authentication code CHAIN_MAC_ROOT matches the generated comparison chain message, verification of the root chain message authentication code CHAIN_MAC_ROOT is successful.

According to the verification method using the chain message authentication code with reference to FIG. 15, since only the authentication keys are used for the verification, it may be possible to prevent attempts for falsification and modulation from the outside in a verification phase.

FIG. 16 is a flowchart of a method of generating a child message authentication code according to some example embodiments of the inventive concepts.

Firstly, whether a device includes a sub-tree may be determined (S410). When the device includes a sub-tree, data that is a basis for generating the chain message authentication code may include the chain message authentication code of a child device and a software configuration value of the device (S420). Otherwise, when the device is a leaf node that does not include a sub-tree, data that is a basis for generating the chain message authentication code may include only the software configuration value of the device (S430). The chain message authentication code may be generated by using an authentication key of the device (S440). Finally, the device may generate the chain message authentication code (S450). The device may send the generated chain message authentication code to a parent device thereof for verification.

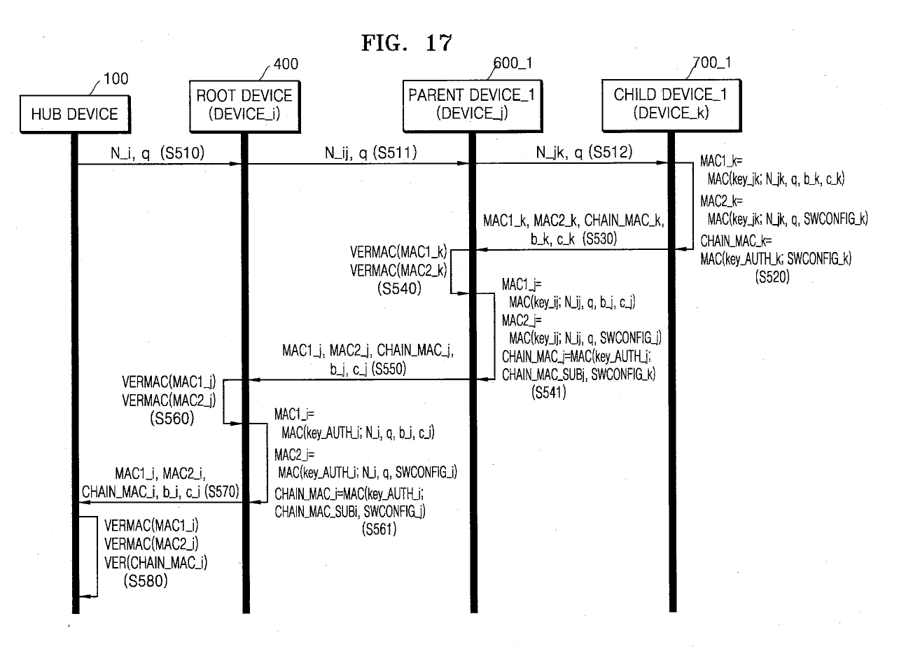

FIG. 17 is a flowchart of a method of verifying a network system according to some example embodiments of the inventive concepts. The network system may include the hub device 100 and a plurality of end-node devices including the root device 400, a first parent device 600_1, and a first child device 700_1. Although the first child device 700_1 is described as a device corresponding to a leaf node having no sub-tree, this is only anon-limiting illustrative example, and a depth of the whole tree structure may be greater than three according to some example embodiments. In addition, for convenience of description, it is assumed that the root device 400 is the i^{th} end-node device DEVICE_i, the first parent device 600_1 is a j^{th} end-node device DEVICE _j, and the first child device 700_1 is a k^{th} end-node device DEVICE_k.

In the integrity verification phase, the hub device 100 and the plurality of end-node devices including the root device 400, the first parent device 600_1, and the first child device 700_1 may generate and share values of N and q to increase the security and reliability of verification. The hub device 100 may transmit values of N_i (N between the hub device 100 and the root device 400) and q to the root device 400 (S510). The root device 400 may transmit values of N_ij (N between the root device 400 and the first parent device 600_1) and q to the first parent device 600_1 (S511). The first parent device 600_1 may transmit values of N_jk (N between the first parent device 600_1 and the first child device 700_1) and q to the first child device 700_1 (S512).

The first child device 700_1 may generate at least one child message authentication code (S520). The first child device 700_1 may generate a first child message authentication code MAC1_k by using a jk^{th} hash key KEY_jk based on the values of N_jk, q, b_k (b of the first child device 700_1), and c_k (c of the first child device 700_1). When the first child device 700_1 is a device corresponding to a leaf node, the values of b_k and c_k may be 0. The first child device 700_1 may generate a second child message authentication code MAC2_k by using the jk^{th} hash key KEY_jk based on N_jk, q, and a k^{th} software configuration value SWCONFIG_k of the first child device 700_1. The first child device 700_1 may generate a child chain message authentication code CHAIN_MAC_k by using a k^{th} authentication key KEY_AUTH_k of the first child device 700_1 based on the k^{th} software configuration value SWCONFIG_k. The first child device 700_1 may transmit the first child message authentication code MAC1_k, the second child message authentication code MAC2_k, the child chain message authentication code CHAIN_MAC_k, b_k, and c_k to the first parent device 600_1 for verification (S530).

The first parent device 600_1 may verify the first child message authentication code MAC1_k and the second child message authentication code MAC2_k by using the k^{th} software configuration value SWCONFIG_k, the jk^{th} hash key KEY_jk, and values of the received b_k and c_k (S540).

The first parent device 600_1 may generate at least one parent message authentication code (S541). The first parent device 600_1 may generate a first parent message authentication code MAC1_j by using an ij^{th} hash key KEY_ij based on N_ij (N between the root device 400 and the first parent device 600_1), q, b_j (b of the first parent device 600_1), and c_j (c of the first parent device 600_1). Values of b_j and c_j may be determined based on a verification result of the child devices thereof (e.g., the first child device 700_1, a second child device 700_2 (not illustrated), etc.). The first parent device 600_1 may generate a second parent message authentication code MAC2_j by using the ij^{th} hash key KEY_ij based on N_ij, q, and a j^{th} software configuration value SWCONFIG_j of the first parent device 600_1. The first parent device 600_1 may generate a parent chain message authentication code CHAIN_MAC_j by using a j^{th} authentication key KEY_AUTH_j of the first parent device 600_1 based on at least one sub-tree chain message authentication code CHAIN_MAC_SUBj received from the child devices thereof and the j^{th} software configuration value SWCONFIG_j. The received at least one sub-tree chain message authentication code CHAIN_MAC_SUBj may include the child chain message authentication code CHAIN_MAC_k received from the first child device 700_1, for example. The first parent device 600_1 may transmit the first parent message authentication code MAC1_j, the second parent message authentication code MAC2_j, the parent chain message authentication code CHAIN_MAC_j, b_j, and c_j to the root device 400 for verification (S550).

The root device 400 may verify the first parent message authentication code MAC1_j and the second parent message authentication code MAC2_j by using the j^{th} software configuration value SWCONFIG_j, the ij^{th} hash key KEY_ij, and values of the received b_j and c_j (S560).

The root device 400 may generate at least one root message authentication code (S561). The root device 400 may generate a first root message authentication code MAC1_i by using an i^{th} authentication key KEY_AUTH_j based on values of N_i (N between the hub device 100 and the root device 400), q, b_i (b of the root device 400), and c_i (c of the root device 400). Values of b_i and c_i may be determined based on the verification result of the child devices thereof (e.g., the first parent device 600_1, a second parent device 600_2 (not illustrated), etc.). The root device 400 may generate a second root message authentication code MAC2_i by using the i^{th} authentication key KEY_AUTH_i based on values of N_i, q, and an i^{th} software configuration value SWCONFIG_i of the root device 400. The root device 400 may generate a root chain message authentication code CHAIN_MAC_i by using the i^{th} authentication key KEY_AUTH_i based on at least one sub-tree chain message authentication code CHAIN_MAC_SUBi received from the child devices thereof and the i^{th} software configuration value SWCONFIG_i. The received at least one sub-tree chain message authentication code CHAIN_MAC_SUBi may include the parent chain message authentication code CHAIN_MAC_j received from the first parent device 600_1, for example. The root device 400 may transmit the first and second root message authentication codes MAC1_i and MAC2_i, the root chain message authentication code CHAIN_MAC_i, b_i, and c_i to the hub device 100 for verification (S570).

The hub device 100 may verify the first and second root message authentication codes MAC1_j and MAC2_i by using the i^{th} software configuration value SWCONFIG_i, the i^{th} authentication key KEY_AUTH_i, and values of the received b_i and c_i (S580). The hub device 100 may verify the first root message authentication code MAC1_i by comparing whether the values of b_i and c_i of the root device 400 are equal to the total number of end-node devices minus 1. In addition, the hub device 100 may verify the root chain message authentication code CHAIN_MAC_i based on the authentication keys of the plurality of end-node devices and the software configuration values of the plurality of end-node devices.

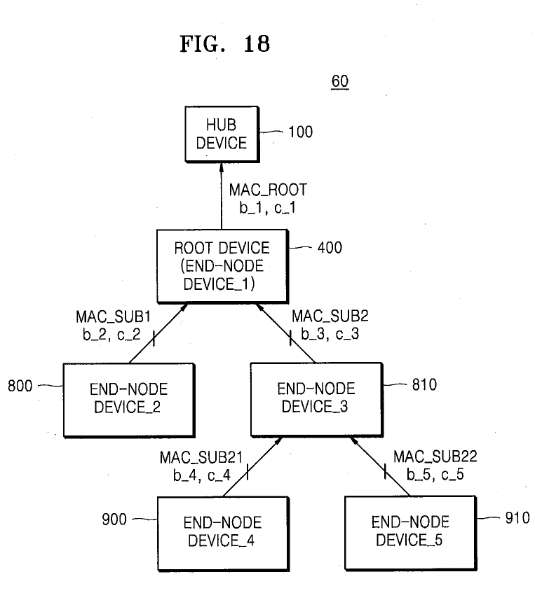

FIG. 18 illustrates a network system 60 according to some example embodiments of the inventive concepts. The network system 60 may include the hub device 100 and a plurality of end-node devices 400, 800, 810, 900, and 910. In the integrity verification phase, the hub device 100 may determine the root device 400 and may form a tree structure with the root device 400 as the root node. For convenience of explanation, it is assumed that the root device 400 is a first end-node device, a second end-node device 800 and a third end-node device 810 are child devices of the root device 400, and a fourth end-node device 900 and a fifth end-node device 910 are child devices of the third end-node device 810. However, the number of end-node devices and a shape of the tree structure are non-limiting illustrative examples only, and some example embodiments are not limited thereto.

The fourth end-node device 900 may transmit at least one sub-tree message authentication code MAC_SUB21, b_4, and c_4 to the third end-node device 810 for verification. The fifth end-node device 910 may transmit at least one sub-tree message authentication code MAC_SUB22, b_5, and c_5 to the third end-node device 810 for verification. Since the fourth and fifth end-node devices 900 and 910 correspond to leaf node devices having no child devices, all values of b_4, c_4, b_5, and c_5 may be 0.

The third end-node device 810 may verify at least one of the received sub-tree message authentication codes MAC_SUB21 and MAC_SUB22. When both of the verifications have passed, both values of b_3 and c_3 of the third end-node device 810 may be 2. The third end-node device 810 may transmit at least one sub-tree message authentication code MAC_SUB2, b_3, and c_3 to the root device 400 for verification. The second end-node device 800 may transmit at least one sub-tree message authentication code MAC_SUB1, b_2, and c_2 to the root device 400 for verification. Since the second end-node device 800 corresponds to a leaf node device having no child device, both values of b_2 and c_2 may be 0.

The root device 400 may verify at least one of the received sub-tree message authentication codes MAC_SUB1 and MAC_SUB2. When both of the verifications have passed, both values of b_1 and c_1 of the root device 400 may be 4. The root device 400 may transmit at least one root message authentication code MAC_ROOT, b_1, and c_1 to the hub device 100 for verification.

The hub device 100 may verify the received at least one root message authentication code MAC_ROOT. In this manner, the hub device 100 may verify the integrity of the whole network system 60.

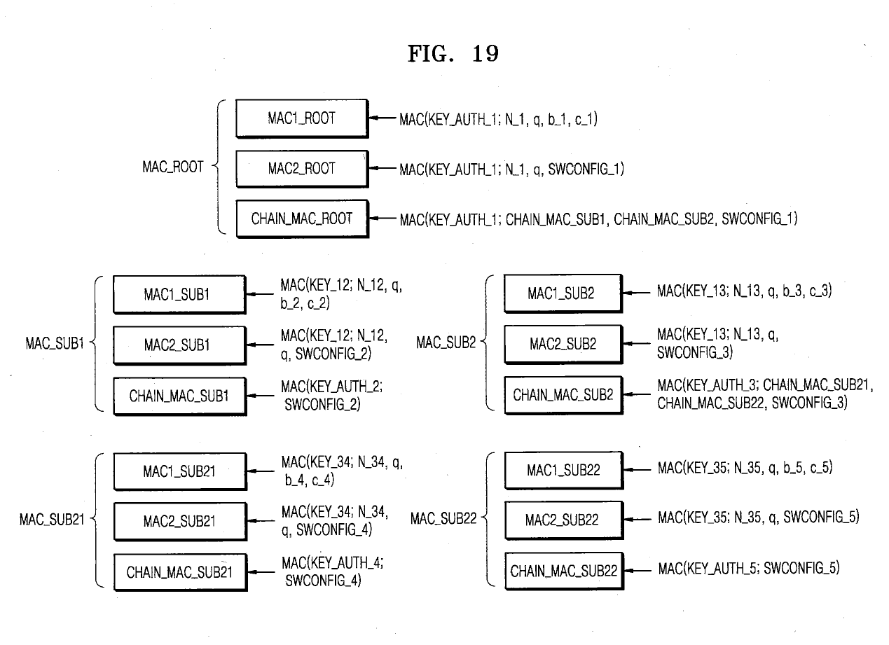

FIG. 19 illustrates message authentication code configurations according to some example embodiments of the inventive concepts. FIG. 19 illustrates the message authentication code configurations transmitted in the network system 60 of FIG. 18.

Referring to FIGS. 18 and 19, at least one sub-tree message authentication code MAC_SUB21 generated by the fourth end-node device 900 may include a first sub-tree message authentication code MAC1_SUB21, a second sub-tree message authentication code MAC2_SUB21, and a sub-tree chain message authentication code CHAIN_MAC_SUB21. The first sub-tree message authentication code MAC1_SUB21 may be generated by using a hash key KEY_34 based on N_34, q, b_4, and c_4. The second sub-tree message authentication code MAC2_SUB21 may be generated by using the hash key KEY_34 based on N_34, q, and a fourth software configuration value SWCONFIG_4. The sub-tree chain message authentication code CHAIN_MAC_SUB21 may be generated by using a fourth authentication key KEY_AUTH_4 based on the fourth software configuration value SWCONFIG_4. It may be understood that at least one of sub-tree message authentication codes MAC_SUB22 and MAC_SUB1 respectively generated by the fifth and second end-node devices 910 and 800 is obtained in this manner

At least one sub-tree message authentication code MAC_SUB2 generated by the third end-node device 810 may include a first sub-tree message authentication code MAC1_SUB2, a second sub-tree message authentication code MAC2_SUB2, and a sub-tree chain message authentication code CHAIN_MAC_SUB2. The first sub-tree message authentication code MAC1_SUB2 may be generated by using a hash key KEY_13 based on N_13, q, b_3, and c_3. The second sub-tree message authentication code MAC2_SUB2 may be generated by using the hash key KEY_13 based on N_13, q, and a third software configuration value SWCONFIG_3. The sub-tree chain message authentication code CHAIN_MAC_SUB2 may be generated by using a third authentication key KEY_AUTH_3 based on the sub-tree chain message authentication code CHAIN_MAC_SUB21 of the fourth end-node device 900, the sub-tree chain message authentication code CHAIN_MAC_SUB22 of the fifth end-node device 910, and the third software configuration value SWCONFIG_3.

At least one root message authentication code MAC_ROOT generated by the root device 400 may include a first root message authentication code MAC1_ROOT, a second root message authentication code MAC2_ROOT, and a root chain message authentication code CHAIN_MAC_ROOT. The first root message authentication code MAC1_ROOT may be generated by using a first authentication key KEY_AUTH_1 based on N_1, q, b_1, and c_1. The second root message authentication code MAC2_ROOT may be generated by using the first authentication key KEY_AUTH_1 based on N_1, q, and a first software configuration value SWCONFIG_1. The root chain message authentication code CHAIN_MAC_ROOOT may be generated by using the first authentication key KEY_AUTH_1 based on the sub-tree chain message authentication code CHAIN_MAC_SUB1 of the second end-node device 800, the sub-tree chain message authentication code CHAIN_MAC_SUB2 of the third end-node device 810, and the software configuration value SWCONFIG_1.

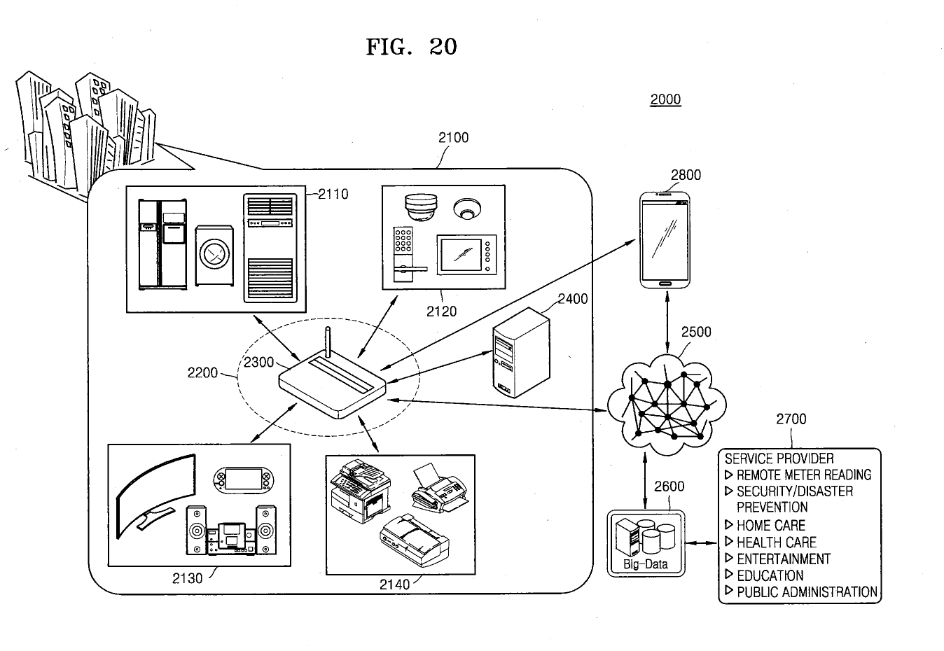

FIG. 20 illustrates an Internet of Things (IoT) system 2000 according to some example embodiments of the inventive concepts. The IoT system 2000 may include a home network system 2100 including IoT devices 2110 through 2140. In addition, the IOT system 2000 may further include an external communication network 2500, a server 2600, a service provider 2700, and a mobile device 2800.

The home network system 2100 may be an example of technology for controlling various devices in a building (e.g., a house, an apartment, an office, etc.) via a wired/wireless network and sharing content among devices. The home network system 2100 may include the IoT devices 2110 through 2140, a home network 2200, and a home gateway 2300. The home network system 2100 may further include a home server 2400.

The IoT device 2110 may include, for example, an appliance, such as a refrigerator, a washing machine, and an air conditioner. The IoT device 2120 may include, for example, a door lock, a CCTV camera, an interphone, a window sensor, a fire sensor, and an electric plug. The IoT device 2130 may include, for example, an entertainment device, such as a TV, an audio device, a game console, and a computer. The IoT device 2140 may include, for example, an office device, such as a printer, a projector, and a photocopy machine. In addition, the IoT devices 2110 through 2140 may include various other electronic devices or sensing devices. The IoT devices 2110 through 2140 may communicate with each other via the home network 2200 and/or the home gateway 2300.

The IoT devices 2110 through 2140 may be connected to the external communication network 2500 via the home gateway 2300. The home gateway 2300 may convert protocols between the home network 2200 and the external communication network 2500, and connect the home network 2200 and the external communication network 2500 to each other. In addition, the home gateway 2300 may convert protocols between various communication networks included in the home network 2200 and connect the IoT devices 2110 through 2140 to the home server 2400. The home gateway 2300 may be separately provided from other devices or may be included in other devices. For example, the home gateway 2300 may be included in the IoT devices 2110 through 2140 or the home server 2400.

The home gateway 2300 and the IoT devices 2110 through 2140 may perform the integrity verification according to the method described with reference to FIGS. 1 through 19. The home gateway 2300 may be a hub device according to FIGS. 1 through 19, and the IoT devices 2110 through 2140 may be a plurality of end-node devices according to FIGS. 1 through 19. Accordingly, the home gateway 2300 may determine a root device among the IoT devices 2110 through 2140 and form a tree structure having the root device as the root node. The root device may verify the integrity of its sub-tree and may transmit at least one root message authentication code to the home gateway 2300 based on a result of verifying the integrity. In the integrity verification, the authentication keys of the IoT devices 2110 through 2140 may be used as symmetric keys. The at least one root message authentication code may include a chain message authentication code.

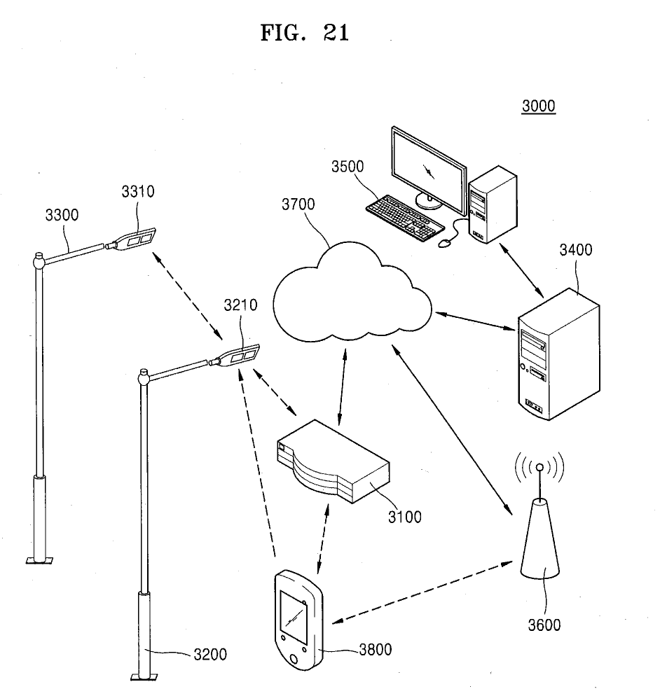

FIG. 21 illustrates an example of a network system 3000 applied to an open space according to some example embodiments of the inventive concepts. The network system described with reference to FIGS. 1 through 20 may be applied not only to a closed space such as a building (e.g., a home, an apartment, an office, etc.), but also to an open space such as a street and a park. The network system 3000 may include a communication connection device 3100, a plurality of lighting devices 3200 and 3300 which are installed at certain distance intervals and communicably connected to the communication connection device 3100, a server 3400, a computer 3500 for controlling the server 3400, a communication base station 3600, a communication network 3700 for connecting the above-mentioned communicable devices, and a mobile device 3800.

The plurality of lighting devices 3200 and 3300 installed in an open external space such as a street and a park may respectively include smart engines 3210 and 3310. The smart engines 3210 and 3310 may include light-emitting devices for emitting light, drivers for driving the light-emitting devices, sensors for collecting information about a surrounding environment, and communication modules.

The communication connection device 3100 may be an access point (AP) configured to perform wired/wireless communication and may mediate communication between the communication network 3700 and other devices. The communication connection device 3100 may be connected to the communication network 3700 via at least one wired/wireless method, and may be mechanically stored, for example, in any one of the lighting devices 3200 and 3300.

The communication connection device 3100 may be connected to the mobile device 3800 via a wireless communication protocol such as WiFi, for example. A user of the mobile device 3800 may receive surrounding environment information collected by the smart engines 3210 and 3310 via the communication connection device 3100 connected to the smart engines 3210 and 3310 of the lighting devices 3200 and 3300 in the neighborhood. The surrounding environment information may include nearby traffic information, weather information, and the like.

The communication connection device 3100 or the server 3400 may verify the integrity of the lighting devices 3200 and 3300 and the mobile device 3800. The communication connection device 3100 or the server 3400 may determine a root device among the lighting devices 3200 and 3300 and the mobile device 3800, and form a tree structure with the root device as a root node. The root device may verify the integrity of its sub-tree and generate at least one root message authentication code based on a result of verifying the integrity. In the integrity verification, authentication keys of the devices may be used as symmetric keys, and at least one message authentication code may include a chain message authentication code. A more detailed description of the integrity verification scheme may be understood with reference to FIGS. 1 through 19.

As described above, some example embodiments have been disclosed in the drawings and specification. While some example embodiments have been described herein with reference to specific terms, it should be understood that they have been used only for the purpose of describing the technical ideas of the inventive concepts and not for limiting the scope of the inventive concepts as defined in the claims. Therefore, it will be clearly understood by one of ordinary skill in the art that various modifications and equivalent example embodiments are possible without departing from the scope of the inventive concepts. Accordingly, the true scope of protection of the inventive concepts should be determined by the technical ideas of the following claims.

What is claimed is:

1. A method of verifying integrity of an Internet of Things (IoT) system comprising a hub device and a plurality of end-node devices, the method comprising:
determining, by the hub device, a root device among the plurality of end-node devices;
receiving, by the hub device from the root device, at least one root message authentication code generated based on a result of verifying integrity of a sub-tree of the root device, wherein the sub-tree of the root device comprises a subset of the plurality of end-node devices subordinate to the root device at a time of integrity verification; and
verifying, by the hub device, the at least one root message authentication code.

2. The method of claim 1, wherein the verifying the at least one root message authentication code comprises verifying, by the hub device, the at least one root message authentication code encrypted with an authentication key of the root device by using an authentication key generated in the hub device.

3. The method of claim 2, wherein the authentication key of the root device is stored in a security chip of the root device, and the authentication key generated in the hub device is generated by using an authentication message received from the root device, upon the root device being connected to the hub device.

4. The method of claim 1, wherein the at least one root message authentication code comprises a first root message authentication code generated based on a number of end-node devices of which integrities have been verified among the subset of the plurality of end-node devices included in the sub-tree of the root device, and a second root message authentication code generated based on a software configuration value of the root device.

5. The method of claim 4, wherein the software configuration value of the root device comprises at least one of process memory map information of the root device and security policy information of the root device.

6. The method of claim 4, wherein the at least one root message authentication code further comprises a root chain message authentication code generated by using an authentication key of the root device based on at least one chain message authentication code received from the subset of the plurality of end-node devices included in the sub-tree of the root device and the software configuration value of the root device.

7. The method of claim 1, wherein the subset of the plurality of end-node devices included in the sub-tree of the root device comprises a parent device and at least one child device subordinate to the parent device at the time of integrity verification, and the method of verifying integrity of the IoT system further comprises:
verifying, by the root device, integrity of the parent device and the at least one child device included in the sub-tree of the root device based on at least one verification loop comprising,
receiving, by the parent device from the at least one child device, at least one child message authentication code generated based on a result of verifying integrity of a sub-tree of the at least one child device, wherein the sub-tree of the at least one child device comprises a subset of the plurality of end-node devices subordinate to the at least one child device; and
verifying, by the parent device, the at least one child message authentication code.

8. The method of claim 7, wherein the verifying the at least one child message authentication code comprises verifying, by the parent device, the at least one child message authentication code encrypted by a hash key shared between the at least one child device and the parent device by using the hash key.

9. The method of claim 8, wherein, upon the at least one child device or the parent device being connected to the hub device, the hash key is generated by a mutual data exchange between the at least one child device and the parent device and stored in the at least one child device and the parent device.

10. The method of claim 7, wherein the at least one child message authentication code comprises a first child message authentication code generated based on a number of end-node devices of which integrities have been verified among the subset of the plurality of end-node devices included in the sub-tree of the at least one child device, and a second child message authentication code generated based on a software configuration value of the at least one child device.

11. The method of claim 10, wherein the software configuration value of the at least one child device is shared by the plurality of end-node devices including the parent device.

12. The method of claim 10, wherein the software configuration value of the at least one child device comprises at least one of process memory map information of the at least one child device and security policy information of the at least one child device.

13. The method of claim 10, wherein the at least one child message authentication code further comprises a child chain message authentication code generated by using an authentication key of the at least one child device based on at least one chain message authentication code received from the subset of the plurality of end-node devices included in the sub-tree of the at least one child device and the software configuration value of the at least one child device.

14. A hub device communicating with a plurality of end-node devices, the hub device comprising:
a memory configured to store computer-readable instructions; and
at least one processor configured to execute the computer-readable instructions to command the hub device to perform operations for verifying integrity of the plurality of end-node devices including,
determining a root end-node device among the plurality of end-node devices and forming a tree structure with the root end-node device as a root node;
receiving at least one root message authentication code from the root end-node device; and
encrypting the at least one root message authentication code by using an authentication key of the root end-node device.

15. The hub device of claim 14, wherein, upon the hub device being connected to a new end-node device, the at least one processor is configured to execute the computer-readable instructions to cause the hub device to perform:
receiving an authentication message and a software configuration value of the new end-node device from the new end-node device; and
generating an authentication key of the new end-node device from the authentication message by using an identifier and a secret key stored in the hub device.

16. The hub device of claim 14, wherein the at least one root message authentication code comprises:
a first root message authentication code generated by the root end-node device based on a result of integrity verification of a sub-tree of the root end-node device after the root end-node device verifies the integrity of the sub-tree of the root end-node device, wherein the sub-tree of the root end-node device comprises a subset of the plurality of end-node devices subordinate to the root end-node device at a time of integrity verification;
a second root message authentication code generated by the root end-node device based on a software configuration value of the root end-node device; and
a root chain message authentication code generated by the root end-node device by using the authentication key of the root end-node device based on at least one chain message authentication code received from the subset of the plurality of end-node devices included in the sub-tree of the root end-node device and the software configuration value of the root end-node device.

17. The hub device of claim 16, wherein the software configuration value of the root end-node device comprises at least one of process memory map information of the root end-node device and security policy information of the root end-node device.

18. A method of verifying integrity of a network system comprising a server and a plurality of clients, the method comprising:
receiving, by a root client determined arbitrarily among the plurality of clients, at least one child message authentication code from a child client of the root client;
verifying, by the root client, integrity of the at least one child message authentication code;
generating, by the root client, at least one root message authentication code by using an authentication key of the root client based on a result of verifying the integrity of the at least one child message authentication code and a software configuration value of the root client, wherein the authentication key of the root client is stored in the root client; and
transmitting, by the root client, the at least one root message authentication code to the server for verification.

19. The method of claim 18, wherein:
the at least one child message authentication code comprises,
a first child message authentication code generated by using a hash key shared between the root client and the child client based on a number of devices of which integrities have been verified among a subset of the plurality of clients subordinate to the child client and forming a sub-tree of the child client;
a second child message authentication code generated by using the hash key based on a software configuration value of the child client; and
a child chain message authentication code generated by using an authentication key of the child client based on a chain message authentication code of the subset of the plurality of clients included in the sub-tree of the child client and the software configuration value of the child client; and
the verifying the integrity of the at least one child message authentication code comprises verifying, by the root client, the first child message authentication code and the second child message authentication code by using the hash key.

20. The method of claim 19, wherein:
the generating the at least one root message authentication code comprises, generating, by the root client, a first root message authentication code by using the authentication key of the root client based on the result of verifying the integrity of the at least one child message authentication code;
generating, by the root client, a second root message authentication code by using the authentication key of the root client based on the software configuration value of the root client; and
generating, by the root client, a root chain message authentication code by using the authentication key of the root client based on the child chain message authentication code and the software configuration value of the root client; and
the software configuration value of the root client comprises at least one of process memory map information of the root client and security policy information of the root client.
